(19) United States
(12) Patent Application Publication
(10) Pub. No.: US 2026/0109597 A1
(43) Pub. Date: Apr. 23, 2026

(54) ADDITIVE MANUFACTURING METHOD AND EQUIPMENT FOR FABRICATING MICRO-NANO-ATOMIC STRUCTURES

(71) Applicant: ShanghaiTech University, Shanghai (CN)

(72) Inventors: Jicheng FENG, Shanghai (CN); Shirong LIU, Shanghai (CN); Bingyan LIU, Shanghai (CN)

(73) Assignee: ShanghaiTech University, Shanghai (CN)

(21) Appl. No.: 19/367,883

(22) Filed: Oct. 24, 2025

Related U.S. Application Data
(63) Continuation-in-part of application No. 18/570,047, filed on Dec. 13, 2023, now abandoned.

(51) Int. Cl. B82B 3/00; B33Y 10/00; B33Y 30/00

(52) U.S. Cl. CPC B82B 3/0004; B33Y 10/00; B33Y 30/00

(57) ABSTRACT

An additive manufacturing method for fabricating 3D nanostructures, comprising: generating charged species, and controlling a first fluid field to transport the charged species; controlling a second fluid field and a first electric field to transport and screen the charged species, thereby generating charged screened particles for printing; configuring a second electric field to directionally migrate the charged screened particles, enabling them to move to preset printing sites; moving the printing sites in multiple directions to realize 3D printing, the second electric field is generated by three parallel plates connected to external electric potentials, the plates comprise a conductive upper plate connected to V1, a patterned layer connected to V2, and a substrate connected to V3; the upper plate and the patterned layer generate the first electric field, and the patterned layer is located between the upper plate and the substrate, with distances h1 and h2 respectively.

### CROSS REFERENCE TO RELATED APPLICATION

The present application is a Continuation in Part Application of U.S. application Ser. No. 18/570,047 file on Jun. 15, 2022, which claims the benefit of CN 202110761096.3 filed on Jul. 6, 2021. All the above are hereby incorporated by reference in their entirety for all purposes.

### TECHNICAL FIELD

The present disclosure relates to the field of micro-nano-atomic-scale 3D printing, and in particular, to an additive manufacturing method and equipment for fabricating 3D nanostructures.

### BACKGROUND

Micro-nano-atomic-scale additive manufacturing (also referred to as micro-nano-atomic three-dimensional (3D) printing) is a new fabrication technology to add up materials for manufacturing 3D nanostructures. Compared with micro-nano-atomic manufacturing technologies in the related art, micro-nano-atomic-scale additive manufacturing has many advantages; for example, it is inexpensive, it only requires simple equipment, there is a wide range of available printing materials, and objects can be directly printed without using laser, vacuum, or liquid reagent; moreover, micro-nano-atomic-scale additive manufacturing has outstanding potential and superiority especially when it comes to manufacturing of complex 3D nanostructures, 3D nanostructures with a high aspect ratio, and multi-material and multi-scale 3D nanostructures, printing of multiple 3D nanostructures in parallel, and manufacturing of embedded heterostructures.

However, all existing micro-nano-atomic-scale printing techniques have certain limitations. For example, micro-stereolithography suffers from a limited range of printing materials and low resolution, and it is also difficult to print structures that require support materials; two-photon polymerization-based direct laser writing suffers from high printing cost and low printing speed in spite of high resolution; electrohydrodynamic jet printing has strict requirements on the electro-fluid used in printing, and has problems such as nozzle clogging, fluid impurities, and is inapplicable to parallel printing of multiple array structures. Although electron-beam printing and ion-beam printing can be adopted to print 3D nanostructures, they also suffer from a limited range of printing materials, extremely low printing speed, and strict requirements on operating conditions and precursor materials. More importantly, none of the above micro-nano-atomic-scale printing techniques can be used for fast printing and parallel printing of metal materials, while metal materials are uniquely advantageous for their mechanical and electrical performance and micro-nano-atomic-scale manufacturing of metal materials is of great significance to the research of microelectronics and nanophotonics.

Therefore, in order to meet scientific and practical needs, it is necessary to develop a new additive manufacturing method, process, and equipment, so as to rapidly print multi-material, large areas of various arrays of 3D nanostructures in a parallel manner.

### SUMMARY

The present disclosure provides an additive manufacturing method and equipment for fabricating 3D nanostructures, so as to solve problems in the prior art of difficulty in rapidly printing multi-material 3D nanostructures in a parallel manner.

The present disclosure is implemented through the following technical solutions.

The additive manufacturing method for fabricating 3D nanostructures includes:
S0: generating charged species, and controlling a first fluid field to transport the charged species; wherein the charged species include single atoms, atomic clusters, and nanoparticles, which are all summarized into a single representative name “particle” throughout.
S1: controlling a second fluid field and a first electric field to transport and screen the charged species, thereby generating charged screened particles for printing;
S2: configuring a second electric field to directionally migrate the charged screened particles, enabling them to move to preset printing sites;
S3: moving the printing sites in one or more directions to realize printing of 3D structures,
wherein the second electric field is generated by mutually parallel plates connected to external electric potentials, the plates comprise an upper plate made of conductive materials, such as metals, connected to electric potential V1, a patterned layer connected to electric potential V2, and a substrate connected to electric potential V3; the upper plate and the patterned layer generate the first electric field, and the patterned layer is located between the upper plate and the substrate, with distances h1 and h2 respectively.

The additive manufacturing equipment for fabricating 3D nanostructures includes:
a production chamber including: one or more gas flow inlets with controllable flow rates, which generate a first fluid field; a plurality of flowmeters arranged at intervals; a charged species generator; and a production control center connected to the gas flow inlets, flowmeters, and the charged species generator, wherein the production control center controls the first fluid field to transport the charged species; and
a printing chamber, communicated with the production chamber, including: one or more gas flow inlets with controllable flow rates, which generate a second fluid field; three mutually parallel plates connected to external electric potentials, wherein the plates comprise an upper plate (made of metal, for example) connected to electric potential V1, a patterned layer connected to electric potential V2, and a substrate connected to electric potential V3;
wherein the patterned layer is located between the upper plate and the substrate, with distances h1 and h2 respectively; wherein the upper plate and the patterned layer generate a first electric field, which couples with the second fluid field to perform size screening on the charged species to obtain charged screened particles; wherein the three plates generate a second electric field, which is configured to directionally migrate the charged screened particles and enable them to move to preset printing sites; and
a printing control center electrically connected to the three plates, wherein the printing control center further comprises a nano-positioning system for controlling relative movement between the substrate and the patterned layer, so as to control the printing sites to move in a three-dimensional manner.

The additive manufacturing method and equipment for fabricating 3D nanostructures provided in the present disclosure have the following beneficial effects.
1) The whole printing process can be directly carried out under room temperature, which greatly simplifies the equipment configuration, reduces costs, and broadens the operating range and the scope of available printing materials.
2) The whole printing process is operated in a mode where the electric field precisely guides the charged species, and this printing process does not introduce any impurities, so the printed 3D nanostructures have high uniformity and high purity.
3) There are a wide variety of materials for the charged species, serving as the particle source for the printing, resulting in virtually unlimited material choice for the 3D nanostructures. The present disclosure realizes the fast printing of multimaterials onto any surface directly without the need of multisteps of materials transfer encountered in photolithography/electron-beam lithography technologies. The resolution and the feature size of printed materials are comparable with those fabricated by lithography technologies, but the applicable materials have a much wider range than the lithographic fabrications.
4) The related diffusivity in a gas phase for the dispersed species is at least three orders of magnitude higher than that in a corresponding liquid phase. The ultrafast kinetics gives a competitive advantage in the additive manufacturing method, which is its extremely fast printing speed. The direct positive consequence for this is that an array of 3D nanostructures with a large-area can be printed in one pass, resulting in the key advantages for fast and efficient printing. The number of 3D nanostructures ranges from 1 to 100 000 000 (or virtually unlimited number) and printed area covers from microns to centimeters. In combining the movement of the substrate, one can print the many 3D nanostructures over an area of in the order of meters to kilometers with the help of a translational step.
5) The arrangement of the charged species in a fluid can be accurately controlled by the electric field that is configured with proper pattern designs. This enables the printing to reach a high resolution in the range of a single particle size or even as small as a single atom, thus making the resolution down to 0.1 nm.

The present disclosure provides an additive manufacturing method for fabricating 3D nano-structures, which enables low-cost, ultra-fast printing speed, large-area, high-purity, multi-material, ultra-high-resolution, and solves the problems encountered in other nanofabrication techniques in making 3D nanostructures, such as a limited range of available printing materials, low resolution and slow printing speed, and one by one serial printing.

### BRIEF DESCRIPTION OF THE DRAWINGS

FIG. 1 is a schematic diagram of a principle of a 3D printer used in an additive manufacturing method according to the present disclosure.

FIG. 2 is an SEM image of a product with a specific 3D nanostructure printed by an additive manufacturing method according to the present disclosure.

FIG. 3 is an SEM image of a product with a specific 3D nanostructure printed by an additive manufacturing method according to the present disclosure.

FIG. 4 is an SEM image of a product with a specific 3D nanostructure printed by an additive manufacturing method according to the present disclosure.

FIG. 5 is an SEM image of a product with a specific 3D nanostructure printed by an additive manufacturing method according to the present disclosure.

FIG. 6 is a schematic structure diagram of a pattern layer of a 3D printer used in an additive manufacturing method according to the present disclosure, with FIG. 6A being a cross-sectional view and FIG. 6B being a top view.

FIG. 7 is a schematic diagram showing an electric field configuration structure used in an additive manufacturing method according to the present disclosure.

FIG. 8 is a schematic diagram showing coupling of a fluid field and an electric field for screening of charged particles used in an additive manufacturing method according to the present disclosure.

FIG. 9 is a schematic diagram showing coupling of a fluid field and an electric field for screening of charged particles used in an additive manufacturing method according to the present disclosure.

FIG. 10 is a schematic structure diagram of a pattern layer of a 3D printer used in an additive manufacturing method according to the present disclosure, wherein FIG. 10A is a cross-sectional view along Line AB, FIG. 10B is a top view, and FIG. 10C is a cross-sectional view along Line CD.

FIG. 11 is a schematic diagram showing an electric field configuration structure used in an additive manufacturing method according to the present disclosure.

FIGS. 12-14 are schematic diagrams showing exemplary methods of adjusting printing sites according to the present disclosure.

### DETAILED DESCRIPTION

The following describes implementations of the present disclosure by using specific embodiments for verifying the practical feasibility of the method in the present disclosure. A person skilled in the art may easily understand other advantages and effects of the present disclosure from the content disclosed in this specification.

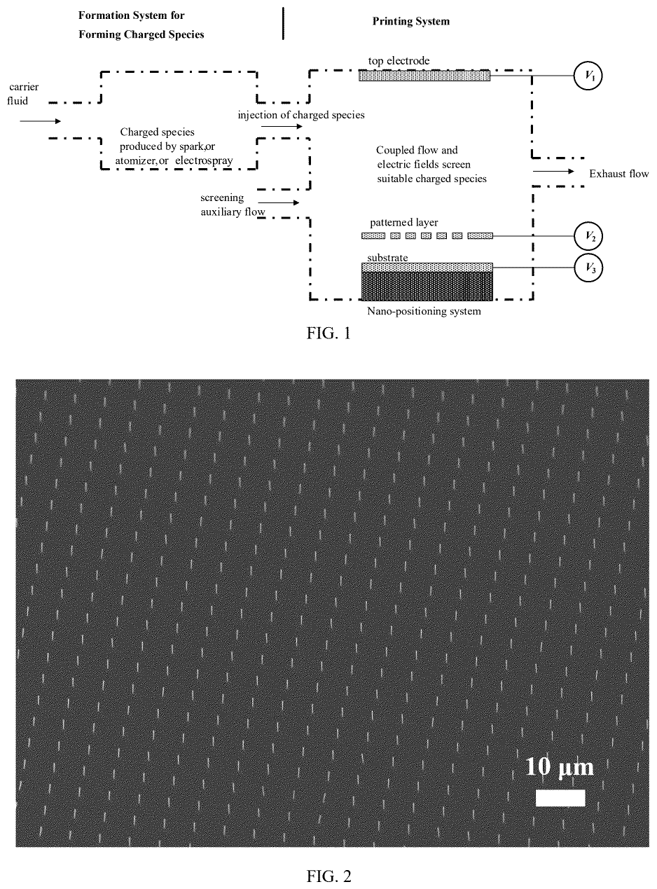

Please refer to FIG. 1 to FIG. 14. It should be noted that the structures, proportions, sizes, and the like shown in the drawings of this specification, in coordination with the content disclosed in this specification, are only used to help a person skilled in the art to read and understand, but are not intended to limit the conditions under which the present disclosure can be implemented. Any modifications to the structure, changes to the proportional relationship or adjustments on the size should fall within the scope of the technical content disclosed by the present disclosure without affecting the effects and the objectives that can be achieved by the present disclosure. In addition, the terms such as “upper”, “lower’, “left”, “right”, “middle”, and “a” used in this specification are also merely for facilitating clear descriptions, but are not intended to limit the scope of implementation of the present disclosure. Without substantially changing the technical contents, changes or adjustments of relative relationships thereof should also fall within the scope of implementation of the present disclosure.

In order to solve the problems encountered in other nanofabrication techniques in making 3D nanostructures, such as low resolution, a limited range of available printing materials, and difficulty in printing metal materials, the present disclosure provides an additive manufacturing method for fabricating 3D nanostructures. In practical manufacturing, a printer may be designed based on the additive manufacturing method of the present disclosure; the printer can implement micro-nano-atomic-scale additive manufacturing with materials that are capable of forming charged species in a gas, and control a geometry and a size of the 3D nanostructure by controlling distribution and strength of an electric field, and movement of a substrate, thereby rapidly printing multi-material, large 3D nanostructures in a parallel manner.

The present disclosure provides an additive manufacturing method for fabricating 3D nanostructures, where charged species dispersed in a fluid are precisely arranged at nanoscale in each dimension with a configured electric field, so that the charged species are printed onto a substrate to form an array of 3D nanostructures as desired. Herein, a configured electric field refers to an electric field whose electric field lines conform to a certain predesigned shape.

Specifically, the method includes:
S0: generating charged species, and controlling a first fluid field to transport the charged species;
S1: controlling a second fluid field and a first electric field to transport and screen the charged species, thereby generating charged screened particles for printing;
S2: configuring a second electric field to directionally migrate the charged screened particles, enabling them to move to preset printing sites;
S3: moving the printing sites in one or more directions to realize printing of 3D structures,
wherein the second electric field is generated by three mutually parallel plates connected to external electric potentials, the plates comprise a conductive upper (made of metal, for example) plate connected to electric potential V1, a patterned layer connected to electric potential V2, and a substrate connected to electric potential V3; the upper plate and the patterned layer generate the first electric field, and the patterned layer is located between the upper plate and the substrate, with distances h1 and h2 respectively.

In an embodiment, the patterned layer is a thin-film structure, including a metal layer sandwiched between insulating layers, wherein the insulating layers are made of insulating supporting materials.

In an embodiment, the supporting materials comprise one or more of silicon nitride, silicon carbide, and silicon dioxide, and the insulating layers have flat and impurity-free surfaces, are is capable of resisting electrostatic force distortion caused by the second electric field.

In an embodiment, the metal layer comprises an active metal layer and a highly conductive metal layer, wherein the active metal layer serves as an adhesion layer to enhance bonding between the metal layer and the insulating layers, wherein the active metal layer is made of one or more of Ti, Cr, Ta, and W, wherein the highly conductive metal layer is made of one or more of Ag, Au, Cu, Pt, Pd, Ir, Rh, and Al.

In an embodiment, the patterned layer comprises arrayed through-holes with an array spacing of P, and the through-holes are circular holes, polygonal holes, or long line-shaped holes.

In an embodiment, the thin film structure of the patterned layer has a thickness of 10 nm˜10 μm, a characteristic size of the through-holes is 10 nm˜10 μm, and the array spacing P is 2˜10 times the characteristic size of the through-holes.

In an embodiment, the method further includes step S4: adjusting a print feature size d by controlling one or more of V₁, V₂, V₃, h₁, h₂ and P, wherein

$$d = p \sqrt{\frac{\vert {V}_{1} - {V}_{2} \vert {h}_{1}}{\vert {V}_{2} - {V}_{3} \vert {h}_{2}}} + {d}_{0} ,$$

wherein do denotes the print feature size when V₁=V₂, and is a constant when the patterned layer remains unchanged structurally and h₁, and h₂ remain unchanged.

In an embodiment, the method further includes step S5: adjusting the electric potentials applied to the plates according to a polarity of the charged species, by making V1>V2>V3 when the charged species are positively charged, and making V1<V2<V3 when the charged species are negatively charged.

In an embodiment, the distance h1 between the patterned layer and the substrate ranges from 1 μm to 1 m, and the distance h2 between the patterned layer and the upper plate ranges from 0 to 100 μm, and more specifically 10 nm to 100 μm.

In an embodiment, step S1 includes:
S11: causing an inert gas or reactive gas to flow in a specific direction to form the second fluid field;
S12: controlling the second fluid field to participate in the transport of the charged species;
S13: controlling the second fluid field along with the first electric field to perform size screening on the charged species, thereby obtaining the charged screened particles.

In an embodiment, step S13 includes:
S13A: configuring the second fluid field and the first electric field such that a fluid drag force of the second fluid field and an electrostatic force of the first electric field are in parallel and opposite directions, in which case, a size cut-off of the size screening is determined by a size corresponding to a condition where the fluid drag force equals the electrostatic force;
S13B: configuring the second fluid field and the first electric field such that the fluid drag force and the electrostatic force are in perpendicular directions, in which case, the size cut-off is determined by a displacement of the charged species caused by the electrostatic force and a displacement caused by the fluid drag force; or
S13C: configuring the second fluid field and the first electric field such that the fluid drag force and the electrostatic force are in neither parallel nor perpendicular directions, in which case, the size screening is determined by a superposition of S13A and S13B.

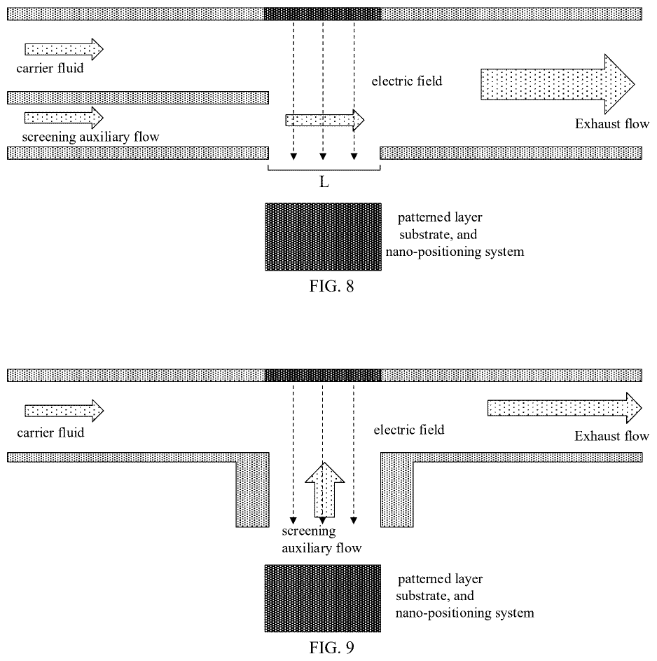

Optionally, as shown in FIG. 8, a screening auxiliary flow (i.e., the second fluid field) is perpendicular to the first electric field. The size of charged screened particles required for printing is controlled by regulating the time it takes for the charged particles brought by the carried fluid to pass above the printing sites while moving downstream in the second fluid field, and the time they take to descend in the electric field. Sizes of obtained charged screened particles are smaller than a size cut-off given by:

$${D}_{p} = \frac{{C}_{c} SneE}{3 π η {Q}_{s}} .$$

S is an area of a printing window; n is the charge quantity of a certain particle (for particles with a diameter less than 10 nm, n=1); e is the unit charge (1.6×10⁻¹⁹ C); E is an electric field intensity applied by V1 and V2; η is a dynamic viscosity of the carrier fluid; Qₛ is a volumetric flow rate of the screening auxiliary flow; and C_{c} is the Cunningham correction factor.

$${C}_{c} = 1 + \frac{λ}{{D}_{p}} [ 2.4 + 1.05 {e}^{( - 0.39 \frac{{D}_{p}}{λ} )} ] ,$$

wherein λ is the mean free path of carrier gas molecules of the carrier fluid.

The Cunningham correction factor quantifies the deviation of a particle's actual drag force from the value predicted by Stokes' Law. Stokes' Law assumes particles are much larger than gas molecules, and the gas acts as a “continuous medium” (no gaps between molecules relative to the particle). For tiny particles, however, gas molecules can “slip” past the particle surface (rather than sticking to it), reducing drag—and the Cunningham correction factor corrects for this slip to calculate accurate drag, terminal velocity, or particle motion.

Suppose that the printing window is rectangular, with a width W, and a length L, then S=W*L. The printing window and the width are perpendicular to the paper surface, and parallel to the plates. The width W may be understood as the width of the second fluid field (or that of the corresponding gas inlet).

It is worth noting that the above screening calculation is performed with particles in the bottom layer of the carrier fluid as the reference example. Certain screened particles in the upper layers may be rendered unusable since they are pushed out by the flow before falling into the printing window. This unusability constitutes an efficiency-related issue, even when the particle size meets specified requirements. However, the retention of particles can be guaranteed to be limited to those with smaller sizes (e.g., smaller than the size cut-off). Therefore, the height of the carrier fluid exerts an influence on efficiency, but shows no direct correlation with size-based screening.

Optionally, as shown in FIG. 9, the screening auxiliary flow is parallel and opposite to the first electric field. The size of charged screened particles required for printing is controlled by regulating the electric field force exerted on the charged particles in the carrier fluid above the printing sites and the drag force exerted on them by the screening auxiliary flow. Sizes of the obtained charged screened particles are smaller than the size cut-off given by the same formula

$${D}_{p} = \frac{{C}_{c} SneE}{3 π η {Q}_{s}} .$$

Note that FIG. 8 and FIG. 9 are exemplary configurations provided to simplify calculations, where the fluid outlet is parallel to the inlet(s) and the two are at the same height. Other configurations may also be taken, see FIG. 1 for example. In an embodiment, shapes, and positions of the inlet(s) and the outlet, and flow rates thereof are so configured that the different fluids within the printing chamber are in a laminar flow state, in which case the flow rate of the carrier fluid has little impact on the screening (and therefor can be omitted from the calculation).

In an embodiment, step S3 comprises: moving the substrate relative to the patterned layer; or moving the patterned layer relative to the substrate, so as to move the printing sites. Note that the printing sites are not material entities, and they are conceptual positions indicating where printing takes place. But they are observable during printing, and other phases as well.

In an embodiment, step S3 comprises: changing one or more of V1, V2, and V3 to move the printing sites.

In an embodiment, the charged species in step SO are generated by plasma-based methods or aerosol-based methods.

In an embodiment, step S2 comprises: pre-adjusting electric field lines of the second electric field on a visualization device according to printing requirements, equipment structure, and printing progress, so as to control the charged screened particles to move along the electric field lines to the preset printing sites.

In an embodiment, the electric potentials of the plates are provided by respective external power supplies.

In an embodiment, a current-limiting resistor is connected in series between the substrate and/or the patterned layer and their respective external power supplies to prevent intense discharge between the substrate and the patterned layer.

In an embodiment, the method further includes adjusting a resistance value of the current-limiting resistor according to a printing speed, wherein the resistance value ranges from 0Ω to 100000 MΩ.

In an embodiment, steps S0, S1, and S2 are performed synchronously, wherein the first fluid field disperses the charged species generated in a production chamber to form an aerosol, which is then transported to a printing chamber for screening, wherein the production chamber and the printing chamber are communicated.

In an embodiment, the method adopts segmented printing, and includes multiple subsidiary printing processes, at least two of which use different printing materials. The segmented printing may be achieved by changing the charged species during printing.

In an embodiment, when the screened particles are atomic clusters. Through screening by the first electric field and the second fluid field, it can be ensured that the clusters used for printing are within this size range, enabling atomic-scale manufacturing and processing.

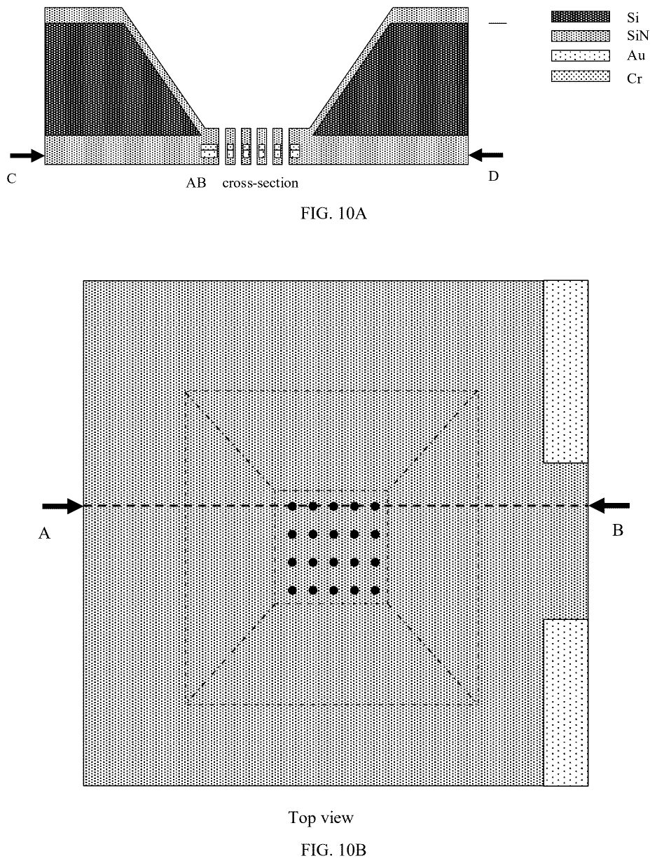

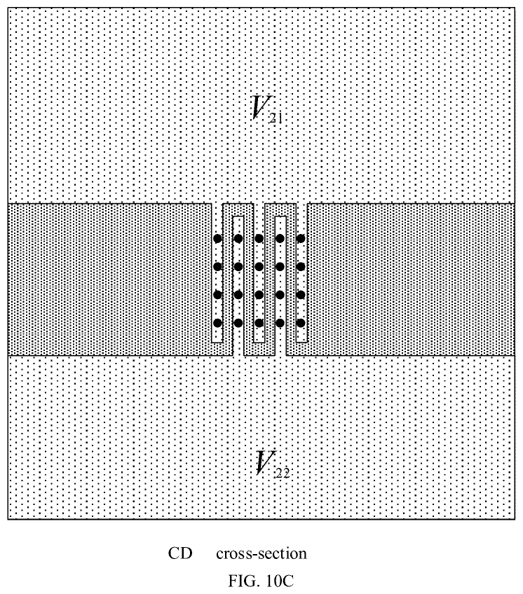

In an embodiment, the metal layer of the patterned layer has a non-uniform potential distribution. Controlled by a microcircuit, the metal layer can have different potentials at different positions, thereby enabling independent adjustment of the printing effect at different positions of the patterned layer. For example, as shown in FIG. 10, the metal layer on the patterned layer is designed for two-potential control and is an arrayed hole plate, where potentials V21 and V22 are alternately distributed on the holes of different columns (or rows). Eventually, different structures can be obtained by printing under the regions of V21 and V22 respectively.

In the additive manufacturing method of the present disclosure, under the action of a spatial electric field, the charged species migrate directionally and are then printed at room temperature, and structures obtained by the above additive manufacturing method have high uniformity and high purity, with no impurities introduced.

The gas involved in the present disclosure is essentially a multiphase fluid with a continuous phase when in a gaseous state and a dispersed phase when in a solid and/or liquid state. In one embodiment, the charged species are liquid and/or solid substance dispersed in the gas. In an embodiment, the charged species have a characteristic size from 0.1 nm to 10 μm. The charged species directionally migrate along electric field lines under the action of the electric field, which ensures effective and controllable printing. Electric charges of the charged species in the micro-nano-atomic-scale are uniform in distribution and migration paths, which ensures high printing precision.

In an embodiment, a material of the charged species includes at least one of an inorganic material, an organic material, and a composite material. In an embodiment, the inorganic material is metal, such as a metal element or an alloy. In an embodiment, the organic material is polymer or a biomolecular material.

The material of the charged species is not limited, and it can be a conductive material, a semiconductive material, or an insulating material. Optionally, the material of the charged species is a compound. Optionally, the charged species include quantum dots. As an example, the charged species can be any material, as long as they can be charged and aerosolized prior to their printing. In an embodiment, when the material of the charged species is conductive or semiconductive, for example, the material of the charged species is metal or semiconductor, the charged species are produced by electrical discharges. In an embodiment, the material of the charged species is a metal element or an alloy, that includes one or more of magnesium, aluminum, titanium, vanadium, chromium, manganese, iron, cobalt, nickel, copper, zinc, gallium, germanium, yttrium, zirconium, niobium, molybdenum, technetium, ruthenium, rhodium, palladium, silver, cadmium, indium, tin, antimony, hafnium, tantalum, tungsten, rhenium, iridium, platinum, gold, lead, and bismuth. In an embodiment, when the material of the charged species is conductive, it may further include a non-metal material including one or more of boron, carbon, silicon, and arsenic. The non-metal material may be an element or a compound composed of the above-mentioned metal element. In an embodiment, the material of the charged species is a high-entropy alloy. In an embodiment, a carrier gas used in the method is one or more of nitrogen, inert gas, oxygen, hydrogen, and chlorine.

In another embodiment, when the dispersed species are in a liquid state, it is transformed into gaseous dispersed species by an atomizer or by electrospray, and the gaseous dispersed species are then transformed into the charged species used by the additive manufacturing method of the present disclosure. In this case, the material of the charged species may be an inorganic material, an organic material, or a composite material.

In an embodiment, the substrate is covered with a patterned layer with opening holes, and the charged species migrate onto the substrate through opening holes in the hollowed patterned layer. In the present disclosure, the opening holes on the patterned layer may be continuous or dispersed. In an embodiment, the opening holes on the patterned layer have dimensions in the micro-nano-atomic range, and have a regular or irregular geometry. In an embodiment, a lower surface of the hollowed patterned layer and the substrate may be in contact with each other or may be separated from each other by a certain distance (e.g., 0-100 μm).

In an embodiment, the spatial electric field includes an externally applied electric field, and an electric field strength of the externally electric field ranges from 1 V/cm to 10000 V/cm or from −10000 V/cm to −1 V/cm.

As a result of the externally applied electric field and local electric fields formed on the surface of the patterned layer, and counterbalancing between the two types of electric fields, the spatial electric field required for printing is constructed. In this case, the spatial electric field is a configured electric field. The electric field lines of the spatial electric field converge at a central region of the opening holes on the patterned layer. The region where the electric field lines converge has dimensions in the sub-nanometer-to-micron range, which are much smaller than those of the opening holes. The region where the electric field lines converge has an electric field strength from one to two orders of magnitude higher than that of other regions (i.e., regions with parallel electric lines), which can induce injection of the charged species and accelerate its directional migration. The degree of convergence of the electric field lines is associated with the strength of the externally applied electric field. If the externally applied electric field is relatively weak, the degree of convergence of the electric field lines will be high, which improves printing precision, but the charged species will be less efficiently accelerated, resulting in a low printing speed. In addition, when the strength of the externally applied electric field dips below a lower critical value, the electric field lines will no longer converge, resulting in failure of printing. If the externally applied electric field is too strong, the electric field lines will also not converge. If the strength of the externally applied electric field reaches above an upper critical value, breakdown will occur in the gas thus sabotaging the whole printing process.

A material of the patterned layer with opening holes may be a dielectric material, such as silicon nitride, silicon oxide, or photoresist, or a conductive material, for example, metal. In an embodiment, the patterned layer with opening holes is conductive; specifically, the patterned layer with opening holes is coated with a conductive layer, and is embedded in an insulator, so that charges will accumulate on surfaces of the patterned layer, thereby increasing the degree of convergence of the electric field lines and achieving fast printing. In addition, the conductive layer may be connected to a power supply so that the power supply can be used to control an electric potential difference across the conductive layer, thereby regulating the degree of converge of the electric lines, the electric field strength, and 3D characteristics of the spatial electric field.

In an embodiment, a geometry and a size of the printed structure are controlled by controlling distribution and/or strength of the spatial electric field, and movement of the substrate. The printing resolution of the charged species is controlled through the spatial electric field. The 3D geometry of the converged electric field lines can be changed through movement of the substrate, so as to accurately arrange migration paths of the charged species, thereby printing a complex 3D structure. The charged species can be injected through a stable channel formed of the converged electric field lines, and onto precise sites. The printing geometry is at least partially determined by movement modes of the substrate. Different movement modes of the substrate are determined by parameters including the translational speed of the substrate relative to the patterned layer with opening holes. But it should be noted that when the speed of the substrate exceeds a threshold, a higher speed of the substrate will no longer impact the printing geometry except when the unfinished structure has a spike that extends upwards. Therefore, the movement of the substrate may be programmatically controlled to print a complex 2D or 3D structure. The printing geometry can also be adjusted by arrangement of the opening holes, positions of the opening holes with respect to the unfinished structure during printing, and distances between the opening holes and the unfinished structure.

In an embodiment, the gas is introduced at a flow rate of 0.1-100 L/min.

In an embodiment, the charged species migrate directionally in a three-dimensional way under the action of the spatial electric field.

The printing method of the present disclosure may be performed in a closed space or in an open space. In order to prevent external interference and provide a safe preparation environment, the printing method of the present disclosure is performed in a closed space in one embodiment.

In an embodiment of the present disclosure, the substrate is connected to a power source, e.g., a voltage source, to control distribution of electric charges in the printed structure. In addition, the substrate moves in different modes, to change the 3D geometry of the converged electric field lines, thereby changing the migration paths of the charged species and printing various products with required 3D nanostructures with dimensions from 1 nm to 10 μm. Although the geometry of the converged electric field lines does not change when the movement of the substrate is accelerated, printing of the charged species at precise sites may be induced by movement of the substrate.

In an embodiment, the charged species may be loaded into and then transported by a carrier gas, introduced to the region where the spatial electric field is, migrated onto the substrate under the action of the spatial electric field, and printed in a preset manner to form a 3D nanostructure. The carrier gas is one or more of nitrogen, inert gas, oxygen, hydrogen, and chlorine.

In the present disclosure, a printer for printing micro-nano-atomic-scale products is provided based on the above additive manufacturing method for fabricating 3D nanostructures, and the printer includes at least a formation system for forming charged species and a printing system. The printer in the present disclosure does not limit the scope of application of the additive manufacturing method, and the method is applicable to any printer that has a particle source system capable of producing charged species.

In an embodiment, the particle source of the charged species is produced by plasma technologies, and the spatial electric field required for printing is configured by combining the externally applied electric field and the local electric fields formed on the surface of the patterned layer with opening holes.

FIG. 1 is a schematic diagram of a principle of an additive manufacturing equipment for fabricating 3D nanostructures (i.e., a 3D printer) used in an additive manufacturing method according to the present disclosure. The 3D printer includes:
a production chamber including one or more gas flow inlets with controllable flow rates, which generate a first fluid field; a plurality of flowmeters arranged at intervals; a charged species generator; and a production control center connected to the gas flow inlets, flowmeters, and the charged species generator, wherein the production control center controls the first fluid field to transport the charged species; and
a printing chamber, communicated with the production chamber, including: one or more gas flow inlets with controllable flow rates, which generate a second fluid field; three mutually parallel plates connected to external electric potentials, wherein the plates comprise a conductive upper plate (made of metal, for example) connected to electric potential V1, a patterned layer connected to electric potential V2, and a substrate connected to electric potential V3; wherein the patterned layer is located between the upper plate and the substrate, with distances h1 and h2 respectively; wherein the upper plate and the patterned layer generate a first electric field, which couples with the second fluid field to perform size screening on the charged species to obtain charged screened particles; wherein the three plates generate a second electric field, which is configured to directionally migrate the charged screened particles and enable them to move to preset printing sites; and a printing control center electrically connected to the three plates, wherein the printing control center further comprises a nano-positioning system for controlling relative movement between the substrate and the patterned layer, so as to control the printing sites to move in a three-dimensional manner.

In an embodiment, the parallel plates include more than three plates; for example, they are multiple patterned layers arranged between the upper plate and the substrate (or in other words, the patterned layer includes one or more sub pattern layers), so as to further fine tune the electric field, and better converge electric field lines.

The number of the patterned layers ranges from 1 to 10, and they are arranged in parallel in sequence. Appropriate electric potentials are applied to each of the patterned layers to control the electric field lines to form multi-stage convergence, ultimately achieving the printing of high-precision and complex 3D architectures.

In one embodiment, as shown in FIG. 11, the number of the patterned layers is 2, with V2A and V2B applied respectively. The distances between the upper plate, the V2A patterned layer, the V2B patterned layer, and the substrate are h1, h2, and h3 in sequence. The applied electric potentials satisfy

$$\vert \frac{{V}_{2 A} - {V}_{1}}{{h}_{1}} \vert < \vert \frac{{V}_{2 B} - {V}_{2 A}}{{h}_{2}} \vert < \vert \frac{{V}_{3} - {V}_{2 B}}{{h}_{3}} \vert$$

and either V₃<V_{2B}<V_{2A}<V₁ (for printing positively charged particles) or V₃>V_{2B}>V_{2A}>V₁ (for printing negatively charged particles), enabling two-stage convergence printing.

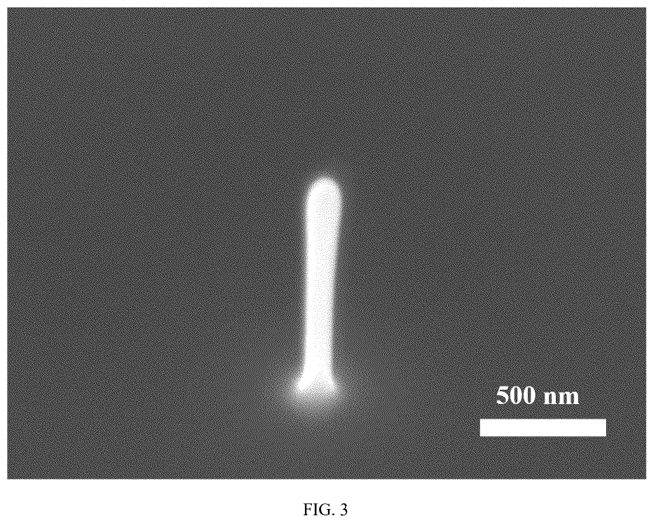

FIGS. 2-5 are SEM images of products with a 3D nanostructure printed by the additive manufacturing method.

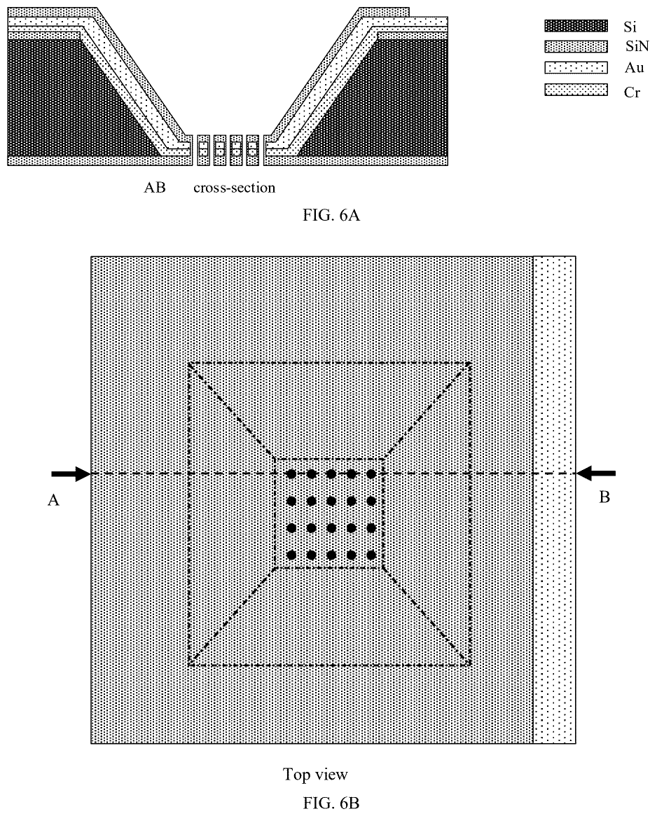

In one embodiment, the structure of the patterned layer is as shown in FIG. 6. It is fabricated from an N-type silicon wafer with a thickness of 300-500 μm. The film structure consists of SiN—Cr—Au—SiN, with corresponding thicknesses of 500-10-50-500 nm respectively. A portion of the metal layer is exposed on the top silicon nitride layer for connecting to the external potential V2. The silicon nitride layers are obtained by LPCVD or PECVD coating, and the metal layers of Cr and Au are obtained by magnetron sputtering or electron beam evaporation. The overall pattern of the patterned layer has a length and width of 1 mm, featuring an array of circular holes with a periodic spacing of 6 μm and a diameter of approximately 2 μm.

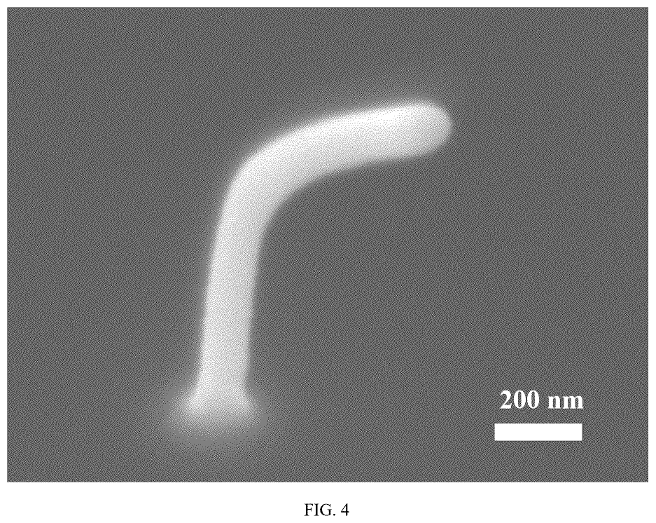

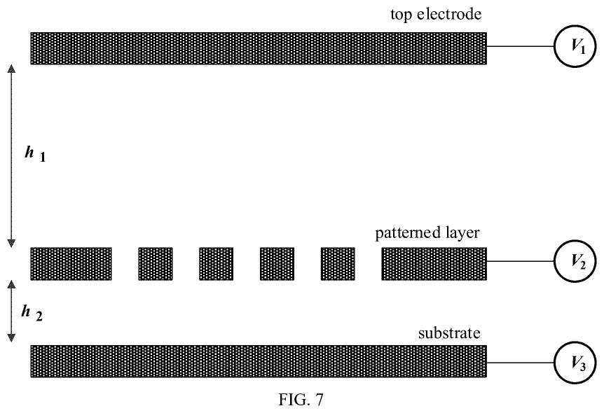

In one embodiment, an electric field configuration structure is as shown in FIG. 7, and the printed structures are as shown in FIGS. 2 and 3. Here, V1=300 V, V2=0 V, V3=−50 V, h1=5 mm, and h2=2 μm.

In one embodiment, a spark is used as a source of the charged screened particles, with the spark parameters as follows: the discharge electrodes of the spark are two Au rods with a diameter of 1 mm and a length of 1 cm; the breakdown voltage is 2 kV; the discharge capacitance is 4 nF; the charging current is 3 mA; the discharge frequency is approximately 350 Hz; and the carrier gas is argon (purity 99.999%) with a flow rate of 2 L/min.

In one embodiment, during the printing process, the patterned layer and the substrate remain relatively stationary. The pattern of the patterned layer is a circular-hole pattern, and the printed structure is an array of upright nanopillars, as shown in FIGS. 2 and 3.

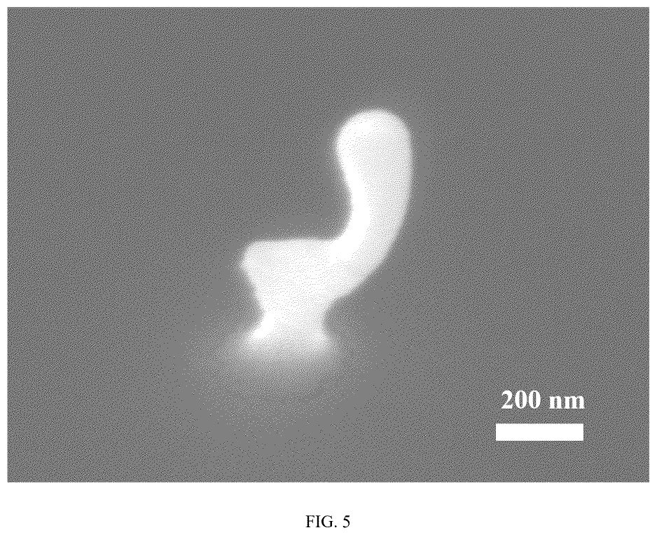

In one embodiment, during the printing process, the substrate first remains stationary for 2 minutes for printing, and then moves uniformly in the lateral direction for 2 minutes with a moving distance of 600 nm, thus printing a cantilever structure, as shown in FIG. 4.

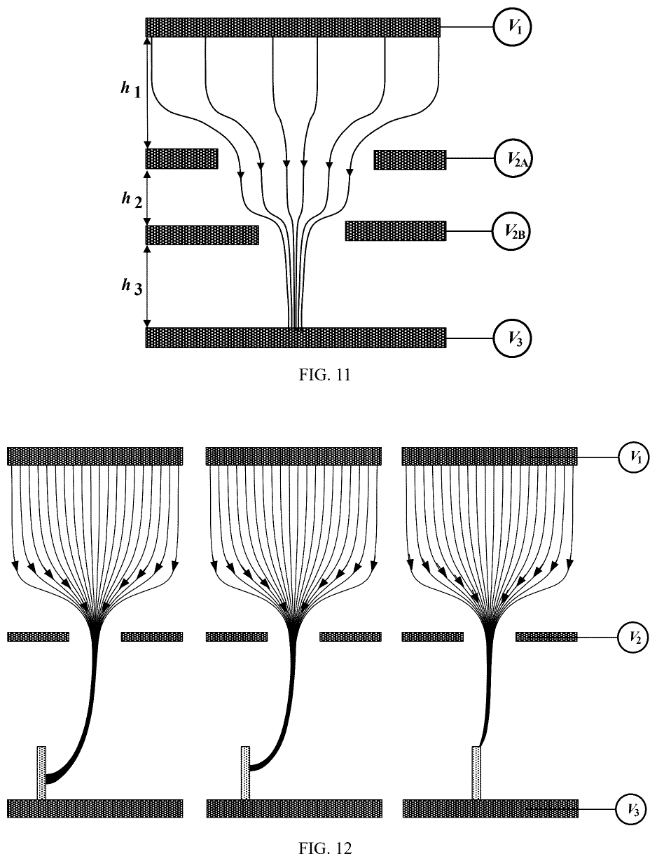

In one embodiment, as shown in FIG. 12, the printing sites of vertical pillar-cantilever structures are controlled by changing the relative position between the substrate and the patterned layer. When an unfinished structure (i.e., a vertical pillar in this case) moves away from a corresponding hole (i.e., the hole closest to the vertical pillar) of the patterned layer, the printing site for this unfinished structure descend; when the structure moves closer to the hole, the printing site rises.

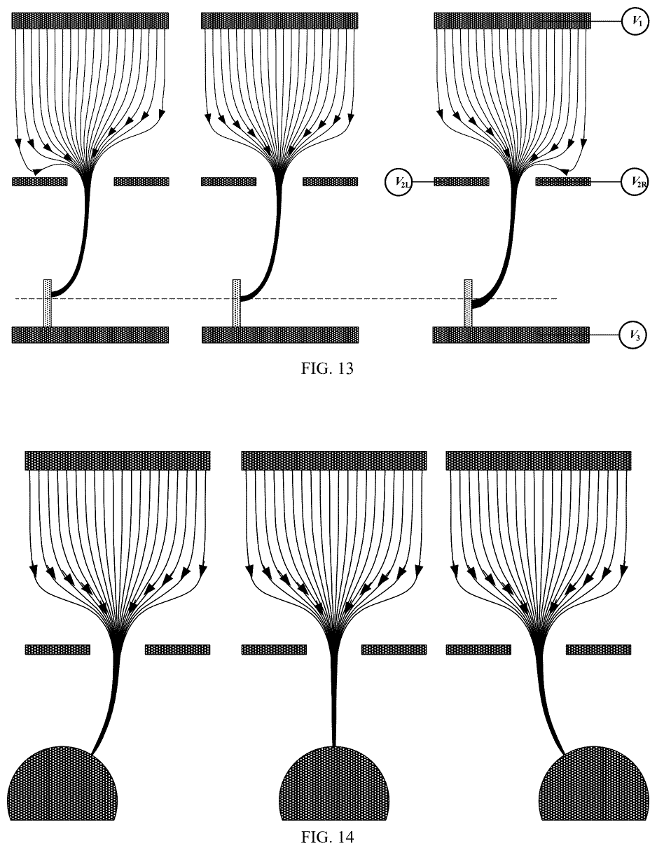

In one embodiment, as shown in FIG. 13, the printing sites of vertical pillar-cantilever structures are controlled by adjusting the potential distribution of the patterned layer. When the vertical pillar is located to the left of the corresponding hole of the patterned layer, reducing the left potential V2L causes the printing site to move downward, while increasing the right potential V2R cause the printing sites to rise.

Optionally, the substrate may have an irregular curved surface; for example, the surface of the substrate may include one or more needle-shaped structures; for example, the substrate has a flexible curved surface.

In one embodiment, as shown in FIG. 14, the substrate has a spherical curved surface. By adjusting the relative position between the spherical curved surface of the substrate and the patterned layer, printing can be performed at different positions on the spherical surface.

As described above, the present disclosure can efficiently print 3D structures with an ultra-high resolution (down to 0.1 nm) at low cost, and can solve problems encountered in other nanofabrication techniques in making 3D nanostructures, such as low resolution, a limited range of available printing materials, and difficulty in printing metal materials.

Therefore, the present disclosure effectively overcomes all the shortcomings of the prior art and has a high industrial value.

The above embodiments are illustrative of the principles and benefits of the disclosure rather than restrictive of the scope of the disclosure. Persons skilled in the art can make modifications and changes to the embodiments without departing from the spirit and scope of the disclosure. Therefore, all equivalent modifications and changes made by persons skilled in the art without departing from the spirit and technical concepts disclosed in the disclosure shall still be deemed falling within the scope of the claims of the disclosure.

What is claimed is:

1. An additive manufacturing method for fabricating 3D nanostructures, comprising:
S0: generating charged species, and controlling a first fluid field to transport the charged species;
S1: controlling a second fluid field and a first electric field to transport and screen the charged species, thereby generating charged screened particles for printing;
S2: configuring a second electric field to directionally migrate the charged screened particles, enabling them to move to preset printing sites;
S3: moving the printing sites in one or more directions to realize printing of 3D structures,
wherein the second electric field is generated by mutually parallel plates connected to external electric potentials, the plates comprise a conductive upper plate connected to electric potential V1, a patterned layer connected to electric potential V2, and a substrate connected to electric potential V3; the upper plate and the patterned layer generate the first electric field, and the patterned layer is located between the upper plate and the substrate, with distances h1 and h2 respectively.

2. The method according to claim 1, wherein the patterned layer is a thin-film structure, comprising a metal layer sandwiched between insulating layers, wherein the insulating layers are made of insulating supporting materials.

3. The method according to claim 2, wherein the supporting materials comprise one or more of silicon nitride, silicon carbide, and silicon dioxide, and the insulating layers have flat and impurity-free surfaces, are is capable of resisting electrostatic force distortion caused by the second electric field.

4. The method according to claim 2, wherein the metal layer comprises an active metal layer and a highly conductive metal layer, wherein the active metal layer serves as an adhesion layer to enhance bonding between the metal layer and the insulating layers, wherein the active metal layer is made of one or more of Ti, Cr, Ta, and W, wherein the highly conductive metal layer is made of one or more of Ag, Au, Cu, Pt, Pd, Ir, Rh, and Al.

5. The method according to claim 1, wherein the patterned layer comprises arrayed through-holes with an array spacing of P, and the through-holes are circular holes, polygonal holes, or long line-shaped holes.

6. The method according to claim 2, wherein the metal layer is controlled by a microcircuit and has different potentials at different positions.

7. The method according to claim 6, further comprising step S4: adjusting a print feature size d by controlling one or more of V₁, V₂, V₃, h₁, h₂ and P, wherein
$$d = p \sqrt{\frac{\vert {V}_{1} - {V}_{2} \vert {h}_{1}}{\vert {V}_{2} - {V}_{3} \vert {h}_{2}}} + {d}_{0} ,$$
wherein d₀ denotes the print feature size when V₁=V₂, and is a constant when the patterned layer remains unchanged structurally and h₁, and h₂ remain unchanged.

8. The method according to claim 1, further comprising step S5: adjusting the electric potentials applied to the plates according to a polarity of the charged species, by making V1>V2>V3 when the charged species are positively charged, and making V1<V2<V3 when the charged species are negatively charged.

9. The method according to claim 1, wherein the patterned layer comprises two or more sub patterned layers arranged in parallel.

10. The method according to claim 1, wherein step S1 comprises:
S11: causing an inert gas or reactive gas to flow in a specific direction to form the second fluid field;
S12: controlling the second fluid field to participate in the transport of the charged species;
S13: controlling the second fluid field along with the first electric field to perform size screening on the charged species, thereby obtaining the charged screened particles.

11. The method according to claim 10, wherein step S13 comprises:
S13A: configuring the second fluid field and the first electric field such that a fluid drag force of the second fluid field and an electrostatic force of the first electric field are in parallel and opposite directions, in which case, a size cut-off of the size screening is determined by a size corresponding to a condition where the fluid drag force equals the electrostatic force;
S13B: configuring the second fluid field and the first electric field such that the fluid drag force and the electrostatic force are in perpendicular directions, in which case, the size cut-off is determined by a displacement of the charged species caused by the electrostatic force and a displacement caused by the fluid drag force; or
S13C: configuring the second fluid field and the first electric field such that the fluid drag force and the electrostatic force are in neither parallel nor perpendicular directions, in which case, the size screening is determined by a superposition of S13A and S13B.

12. The method according to claim 1, wherein step S3 comprises: moving the substrate relative to the patterned layer; or moving the patterned layer relative to the substrate, so as to move the printing sites.

13. The method according to claim 1, wherein step S3 comprises: changing one or more of V1, V2, and V3 to move the printing sites.

14. The method according to claim 1, wherein the charged species in step SO are generated by plasma-based methods or aerosol-based methods.

15. The method according to claim 1, wherein step S2 comprises: pre-adjusting electric field lines of the second electric field on a visualization device according to printing requirements, equipment structure, and printing progress, so as to control the charged screened particles to move along the electric field lines to the preset printing sites.

16. The method according to claim 2, wherein the electric potentials of the plates are provided by respective external power supplies.

17. The method according to claim 2, wherein a current-limiting resistor is connected in series between the substrate and/or the patterned layer and their respective external power supplies to prevent intense discharge between the substrate and the patterned layer.

18. The method according to claim 17, further comprising adjusting a resistance value of the current-limiting resistor according to a printing speed, wherein the resistance value ranges from 0Ω to 100000 MΩ.

19. The method according to claim 1, wherein steps S0, S1, and S2 are performed synchronously, wherein the first fluid field disperses the charged species generated in a production chamber to form an aerosol, which is then transported to a printing chamber for screening, wherein the production chamber and the printing chamber are communicated.

20. An additive manufacturing equipment for fabricating 3D nanostructures, comprising:
a production chamber comprising:
one or more gas flow inlets with controllable flow rates, which generate a first fluid field;
a plurality of flowmeters arranged at intervals;
a charged species generator; and
a production control center connected to the gas flow inlets, flowmeters, and the charged species generator, wherein the production control center controls the first fluid field to transport the charged species; and
a printing chamber, communicated with the production chamber, comprising:
one or more gas flow inlets with controllable flow rates, which generate a second fluid field;
three mutually parallel plates connected to external electric potentials, wherein the plates comprise a conductive upper plate connected to electric potential V1, a patterned layer connected to electric potential V2, and a substrate connected to electric potential V3;
wherein the patterned layer is located between the upper plate and the substrate, with distances h1 and h2 respectively; wherein the upper plate and the patterned layer generate a first electric field, which couples with the second fluid field to perform size screening on the charged species to obtain charged screened particles; wherein the three plates generate a second electric field, which is configured to directionally migrate the charged screened particles and enable them to move to preset printing sites; and
a printing control center electrically connected to the three plates, wherein the printing control center further comprises a nano-positioning system for controlling relative movement between the substrate and the patterned layer, so as to control the printing sites to move in a three-dimensional manner.
